(19) United States
(12) Patent Application Publication
(10) Pub. No.: US 2021/0049539 A1
(43) Pub. Date: Feb. 18, 2021

(54) METHOD AND SYSTEM FOR MAINTAINING CENTER OF GRAVITY OF STORAGE UNITS

(71) Applicant: GREY ORANGE PTE. LTD., Singapore (SG)

(72) Inventors: Priya AGRAWAL, Jaipur (IN); Venakata Sri Harsha PALAPARTHI, Vijayawada (IN); Kumar DEVVRAT, Gurgaon (IN); Jyotirmaya PATRA, Bhubaneshwar (IN)

(73) Assignee: GREY ORANGE PTE. LTD., Singapore (SG)

(21) Appl. No.: 16/538,469

(22) Filed: Aug. 12, 2019

(51) Int. Cl. G06Q 10/08; G01M 1/12

(52) U.S. Cl. CPC G06Q 10/087; G01M 1/122

(57) ABSTRACT

A method for maintaining center of gravity (COG) of a storage unit is provided. A server receives a first request for placing an item in a storage facility. The server identifies a storage unit in the storage facility and slots available in the storage unit for placing the item. The server selects a first slot from the available slots to place the item, such that when the item is placed in the first slot, the COG of the storage unit is maintained within a COG tolerance region of the storage unit. The server further maintains the COG within the COG tolerance region after one or more items are picked from the storage unit. The server identifies new slots for rearranging items remaining in the storage unit after the items are picked and thus maintains the COG of the storage unit within the COG tolerance region.

### FIELD OF THE INVENTION

The present invention relates generally to warehouse management, and, more particularly to a method and a system for maintaining center of gravity of storage units.

### BACKGROUND

Generally, in a storage facility, items are stored in slots of storage units. Each storage unit has a corresponding center of gravity (COG). Position of the COG of a storage unit depends on a weight distribution profile of the storage unit. For example, if heavier items are stored in upper slots of the storage unit and lighter items are stored in lower slots of the storage unit, the COG of the storage unit may lie in the upper portion of the storage unit. Likewise, if heavier items are stored in the lower slots of the storage unit and lighter items are stored in the upper slots of the storage unit, the COG of the storage unit may lie in the lower portion of the storage unit.

Typically, every storage unit has a COG tolerance region such that if the COG of a storage unit lies within the corresponding COG tolerance region, the storage unit may remain stable when moved and may not topple. However, maintaining the COG of a storage unit within the corresponding COG tolerance region is a difficult task. In one exemplary scenario, an operator placing an item in a storage unit might not be aware of the weights of items that are already placed in the storage unit, and hence may not be able to select an appropriate slot for placing the item. The item, if placed in a wrong slot may shift the COG of the storage unit out of the COG tolerance region, thereby making the storage unit unstable. In another scenario, the operator may pick an item from the storage unit. The picking of the item alters the weight distribution profile of the storage unit and may shift the COG of the storage unit out of the corresponding COG tolerance region.

The storage units, for which the COG is not maintained within the corresponding COG tolerance region, may oscillate and topple when transported from one place to another in the storage facility. Toppling of a storage unit not only damages the items stored therein, but may also damage other storage units or objects that are placed nearby. In addition, toppling of the storage units increases the risk factor for humans working in the storage facility and decreases their working efficiency.

In light of the foregoing, there exists a critical need for a solution that maintains COGs of storage units within corresponding COG tolerance region.

### SUMMARY

In an embodiment of the present invention, a method for maintaining a center of gravity (COG) of a first storage unit is provided. A first request for placing at least one item in a storage facility is received by a server. The storage facility includes a plurality of storage units. The first storage unit from the plurality of storage units is identified by the server for placing the item. A set of slots available in the first storage unit for placing the item is identified by the server. A first slot is selected by the server from the set of slots to place the item such that when the item is placed in the first slot, the COG of the first storage unit is maintained within a COG tolerance region of the first storage unit. A placement instruction to place the item in the first slot is communicated by the server to an instruction device associated with an operator. When the operator places the item in the first slot based on the placement instruction, the COG of the first storage unit is maintained within the COG tolerance region.

In another embodiment of the present invention, a system for maintaining a COG of a first storage unit is provided. The system includes a server that is configured to receive a first request for placing at least one item in a storage facility. The storage facility includes a plurality of storage units. The server identifies the first storage unit from the plurality of storage units for placing the item. The server identifies a set of slots available in the first storage unit for placing the item. The server selects a first slot form the set of slots to place the item such that when the item is placed in the first slot, the COG of the first storage unit is maintained within a COG tolerance region of the first storage unit. The server communicates, to an instruction device associated with an operator, a placement instruction to place the item in the first slot. When the operator places the item in the first slot based on the placement instruction, the COG of the first storage unit is maintained within the COG tolerance region.

In another embodiment of the present invention, a method for maintaining a COG of a first storage unit is provided. A first request to pick a first item from a storage facility is received by a server. The storage facility includes one or more storage units that store the first item. Based on the first request, a first storage unit from the one or more storage units is identified by the server for picking the first item. The first item is to be picked from a first slot of the first storage unit. It is determined by the server whether the COG of the first storage unit shifts out of the COG tolerance region, when the first item is picked from the first slot. A first set of slots is identified by the server for rearranging a first set of items remaining in the first storage unit after the first item is picked. When the first set of items is rearranged in the first set of slots, the COG of the first storage unit is maintained within the COG tolerance region. The server communicates, to an instruction device associated with an operator, a pick instruction to pick the first item from the first slot and a rearrangement instruction to rearrange the first set of items in the first set of slots. The COG of the first storage unit is maintained within the COG tolerance region after the first item is picked.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates an exemplary environment, in accordance with an embodiment of the present invention;

FIGS. 2A-2D are block diagrams that collectively illustrate an exemplary scenario for maintaining center of gravities (COGs) of storage units in the storage facility of FIG. 1, in accordance with an embodiment of the present invention;

FIGS. 3A-3D are block diagrams that collectively illustrate an exemplary scenario for maintaining COGs of the storage units in the storage facility of FIG. 1, in accordance with an embodiment of the present invention;

FIG. 4 is a block diagram that illustrates an exemplary scenario for maintaining COGs of the storage units in the storage facility of FIG. 1, in accordance with another embodiment of the present invention;

FIG. 5 is a block diagram that illustrates the control server of FIG. 1, in accordance with an embodiment of the present invention;

FIG. 6 is a block diagram that illustrates system architecture of a computer system, in accordance with an embodiment of the present invention;

FIG. 7 is a flow chart that illustrates a method for maintaining COGs of the storage units of FIG. 1, in accordance with an embodiment of the present invention.

FIGS. 8A and 8B, collectively represent a flow chart that illustrates a method for maintaining COGs of the storage units of FIG. 1, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Generally, storage units in a storage facility need to be transported from one place to another. If the center of gravities (COGs) of the storage units are not maintained within a corresponding COG tolerance region, the storage units may topple during transportation. Maintaining the COGs within the corresponding COG tolerance region is critical for the transportation of goods and timely operation of the storage facility, but a cumbersome task for operators in the storage facility.

Various embodiments of the present invention provide a method and a system for maintaining a COG of a storage unit. In one embodiment, a control server receives a first request for fulfilling a first item in a storage facility. The control server identifies a first storage unit of a plurality of storage units in the storage facility where the first item needs to be placed for fulfillment and instructs a transport vehicle to transport the first storage unit to an operator station. The control server further determines a COG tolerance region of the first storage unit. The COG tolerance region is a permissible COG range such that when a COG of the first storage unit is maintained within the COG tolerance region, the first storage unit remains stable during transportation and does not topple. From all the available slots in the first storage unit, the control server selects a first slot such that when the first item is placed in the first slot, the COG of the first storage unit is maintained within the COG tolerance region of the first storage unit. Based on the selection of the first slot, the control server communicates a placement instruction to an instruction device at the operator station to place the first item in the first slot.

In another embodiment, the control server receives a second request for retrieving a second item from the storage facility. The control server identifies a second storage unit from the plurality of storage units in the storage facility from where the second item needs to be retrieved and instructs the transport vehicle to transport the second storage unit to the operator station. The control server determines a COG tolerance region of the second storage unit. The control server further determines whether the COG of the second storage unit would shift out of the COG tolerance region, if the second item is picked from the second storage unit. When it is determined that picking the second item from the second storage unit would shift the COG of the second storage unit out of the COG tolerance region, the control server identifies new slots in the second storage unit for rearranging items of the second storage unit remaining after the second item is picked. The control server communicates a pick instruction to the instruction device for picking the second item from the second storage unit and a rearrangement instruction to rearrange the remaining items in the new slots.

Thus, the method and system maintain the COGs of the first and second storage units within the corresponding COG tolerance region, thereby preventing the first and second storage units from toppling.

In some embodiments, a “COG” of a storage unit is a point at which a weight of the storage unit may act. The COG of the storage unit depends on a weight distribution profile of the storage unit. For example, if heavier items are stored in upper slots of the storage unit and lighter items are stored in lower slots of the storage unit, the COG of the storage unit may lie in the upper portion of the storage unit. Likewise, if heavier items are stored in the lower slots of the storage unit and lighter items are stored in the upper slots of the storage unit, the COG of the storage unit may lie in the lower portion of the storage unit.

In some embodiments, a “COG tolerance region” is an acceptable range defined for a COG of a storage unit such that when the COG lies within the COG tolerance region, the storage unit is stable and may not topple when moved. The COG tolerance region may be of any shape or size, for example, triangular, spherical, cuboid, or the like.

In some embodiments, a “first request” is a request received by a control server from an external communication system. In one example, the first request may be for fulfilling one or more items in a storage facility. In another example, the first request may be for retrieving one or more items from the storage facility. The first request includes information pertaining to the items that are to be fulfilled in the storage facility or retrieved from the storage facility.

In some embodiments, a “risk score” is a value that indicates a level of risk associated with placing an item in a slot of a storage unit. In one example, a value of the risk score may lie between 0 and 1, where ‘0’ indicates no risk and ‘1’ indicates highest risk. The risk score may also be assigned the value that is the lowest value on the scale (e.g., 0) or the highest value on the scale (e.g., 1). Thus, a lower risk score makes a slot a better placement option for an item. The values 0 and 1, and values in between, are merely examples of a range for a scale, and other ranges (e.g., 0 to 100) may be used.

In some embodiments, a “control server” is a physical or cloud data processing system on which a server program runs. The control server may be implemented in hardware or software, or a combination thereof. In one embodiment, the control server may be implemented in computer programs executing on programmable computers, such as personal computers, laptops, or a network of computer systems.

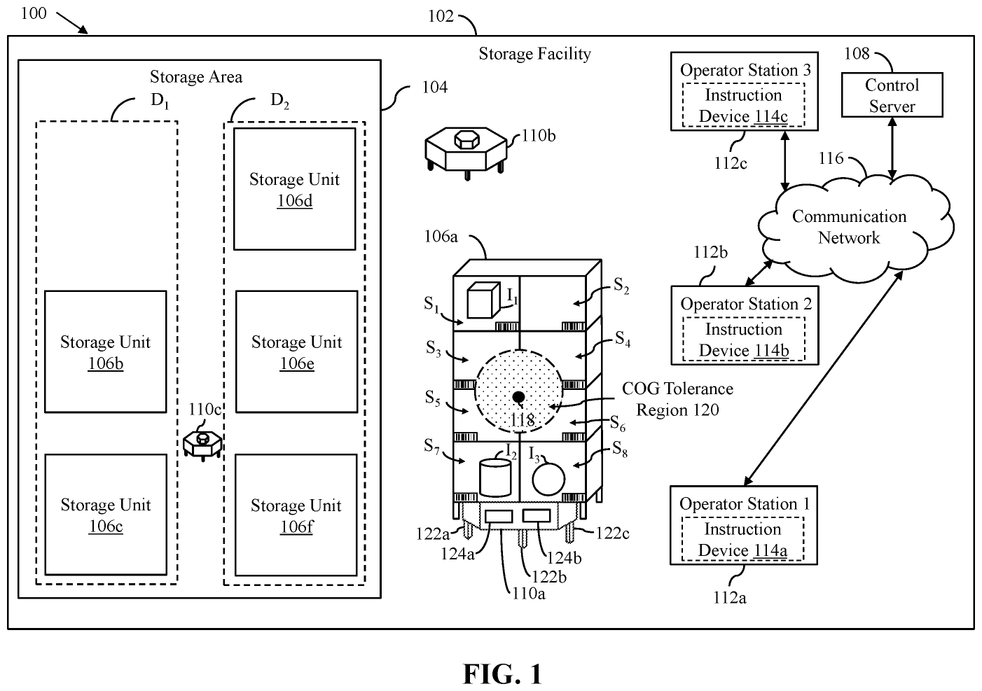

FIG. 1 is a block diagram that illustrates an embodiment of an exemplary environment 100, in accordance with an embodiment of the present invention. The environment 100 shows a storage facility 102. The storage facility 102 includes a storage area 104, first through sixth storage units 106a-106f (hereinafter, the first through sixth storage units 106a-106f are collectively referred to as “storage units 106”), and a control server 108. The storage facility 102 further includes first through third transport vehicles 110a-110c (hereinafter, the first through third transport vehicles 110a-110c are collectively referred to as “transport vehicles 110”) and first through third operator stations 112a-112c (hereinafter, the first through third operator stations 112a-112c are collectively referred to as “operator stations 112”). The operator stations 112 include first through third instruction devices 114a-114c, respectively. Hereinafter, the first through third instruction devices 114a-114c are collectively referred to as “instruction devices 114”. The control server 108 communicates with the transport vehicles 110 and the instruction devices 114 by way of a communication network 116 or through separate communication networks established therebetween.

The storage facility 102 is a facility where multiple items are stored for fulfillment or selling. In one example, the storage facility 102 is a forward warehouse where the items are stored for fulfillment. In another example, the storage facility 102 is a backward warehouse for storing the items for fulfillment. In another example, the storage facility 102 is a retail facility, such as a grocery store, a departmental store, an apparel store, or the like, where the items are stored for selling. The storage facility 102 has the storage area 104 where the storage units 106 are placed for storing the items. The storage units 106 may be arranged to form aisles therebetween. In one exemplary scenario, the storage units 106 are organized in various departments, such as first and second departments ‘D₁’ and ‘D₂’, based on categories of the items stored in the storage units 106. For example, the first department D₁ is a food department D₁ formed by the first through third storage units 106a-106c and the second department D₂ is an apparels department D₂ formed by the fourth through sixth storage units 106d-106f The items within the food department D₁ are stored and displayed in various slots (e.g., shelves or nodes) of the first through third storage units 106a-106c and the items within the apparels department D₂ are stored and displayed in various slots of the fourth through sixth storage units 106d-106f. For example, the first storage unit 106a has first through eighth slots S₁-S₈. First through third items I₁-I₃ are stored and displayed in the first, seventh, and eighth slots S₁, S₇, and S₈, respectively, and the second through sixth slots S₂-S₆ are empty and available for storing other items. The above-described arrangement of the storage facility 102 with the corresponding departments are non-limiting, and the present invention may be incorporated in any storage facility with any desired arrangement.

Each storage unit 106 has a corresponding COG. A position of the COG of each storage unit 106 may vary based on various factors, such as dimensions, configuration, shape, and weight of the corresponding storage unit 106, and dimensions of various slots of the corresponding storage unit 106. The position of the COG of each storage unit 106 may further vary based on a weight, a shape, dimensions, and a storage position of each item stored in the corresponding storage unit 106. For example, the first storage unit 106a has the COG at a first position 118. The first position 118 of the COG of the first storage unit 106a may be based on the dimensions, the shape, the configuration, and the weight of the first storage unit 106a, the dimensions of the first through eighth slots S₁-S₈, and weights, shapes, dimensions, and storage positions of the first through third items I₁-I₃ stored in the first storage unit 106a. The storage positions of the first through third items I₁-I₃ are the first, seventh, and eighth slots S₁, S₇, and S₈.

According to some embodiments, the control server 108 is a network of computers, a software framework, or a combination thereof, that may provide a generalized approach to create the server implementation. Examples of the control server 108 may include, but are not limited to, personal computers, laptops, mini-computers, mainframe computers, any non-transient and tangible machine that can execute a machine-readable code, cloud-based servers, distributed server networks, or a network of computer systems. The control server 108 may be realized through various web-based technologies such as, but not limited to, a Java web-framework, a .NET framework, a personal home page (PHP) framework, or any other web-application framework. The control server 108 may be maintained by a warehouse management authority or a third-party entity.

The control server 108 may receive a first request from an external communication system. In one embodiment, the first request is for fulfilling items in the storage facility 102. In another embodiment, the first request is for retrieving items stored in the storage facility 102 for fulfilling an order. The first request includes information pertaining to the items that are to be fulfilled or retrieved. Based on at least the first request, an exemplary embodiment of an operation of the control server 108 may be performed as follows. The control server 108 identifies one or more storage units from the storage units 106 that are associated with the items of the first request. For example, the control server 108 may identify that the first storage unit 106a in the food department D₁ is associated with the items of the first request. The control server 108 further identifies an optimal path that needs to be traversed in the storage facility 102 for transporting the first storage unit 106a from the storage area 104 to one of the operator stations 112, for example, the first operator station 112a. The control server 108 may use layout information of the storage facility 102 for identifying the optimal path.

The control server 108 further identifies which transport vehicle from the transport vehicles 110 is available for transporting the first storage unit 106a from the storage area 104 to the first operator station 112a. For example, the control server 108 identifies that the first transport vehicle 110a is available based on real-time locations of the transport vehicles 110. The control server 108 further transmits a move instruction to the first transport vehicle 110a for transporting the first storage unit 106a from the storage area 104 to the first operator station 112a. The move instruction includes navigation details (e.g., a virtual map for the optimal path) of the identified optimal path. The control server 108 further determines a COG tolerance region 120 for the first storage unit 106a identified based on the first request. The COG tolerance region 120 defines a permissible COG range for the first storage unit 106a such that if the COG of the first storage unit 106a is maintained within the COG tolerance region 120, the first storage unit 106a is stable and may not topple when moved.

In one embodiment, if the first request is for fulfilling the items in the first storage unit 106a, the control server 108 selects slots from the first through eighth slots S₁-S₈ that are available for storing the items included in the first request. The control server 108 selects the slots from the first through eighth slots S₁-S₈ such that when the items are placed in the selected slots, the COG of the first storage unit 106a is maintained within the COG tolerance region 120. For selecting the slots, the control server 108 determines a risk score for the first through eighth slots S₁-S₈ that are available for storing the items, e.g., the second through sixth slots S₂-S₆.

In another embodiment, if the first request is for retrieving the items from the first storage unit 106a, the control server 108 determines whether the COG of the first storage unit 106a would shift out of the COG tolerance region 120 after the items are picked from the first storage unit 106a based on the first request. In a scenario where it is determined that the COG may shift out of the COG tolerance region 120 after the items are picked from the first storage unit 106a, the control server 108 selects new slots for rearranging remaining items of the first storage unit 106a. The new slots are selected such that the COG is maintained within the COG tolerance region 120 after the rearrangement of the remaining items.

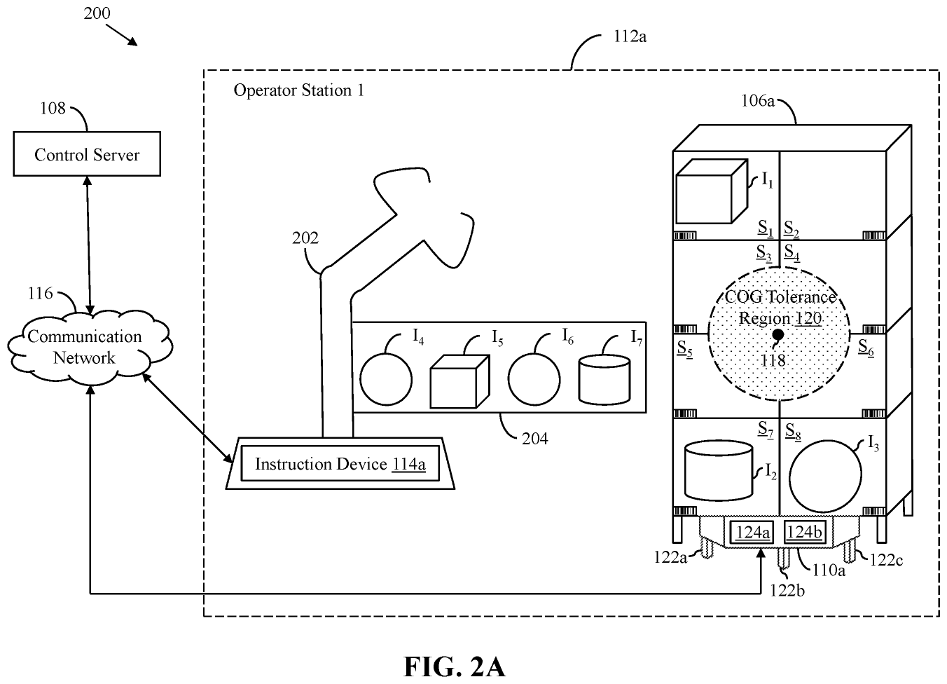

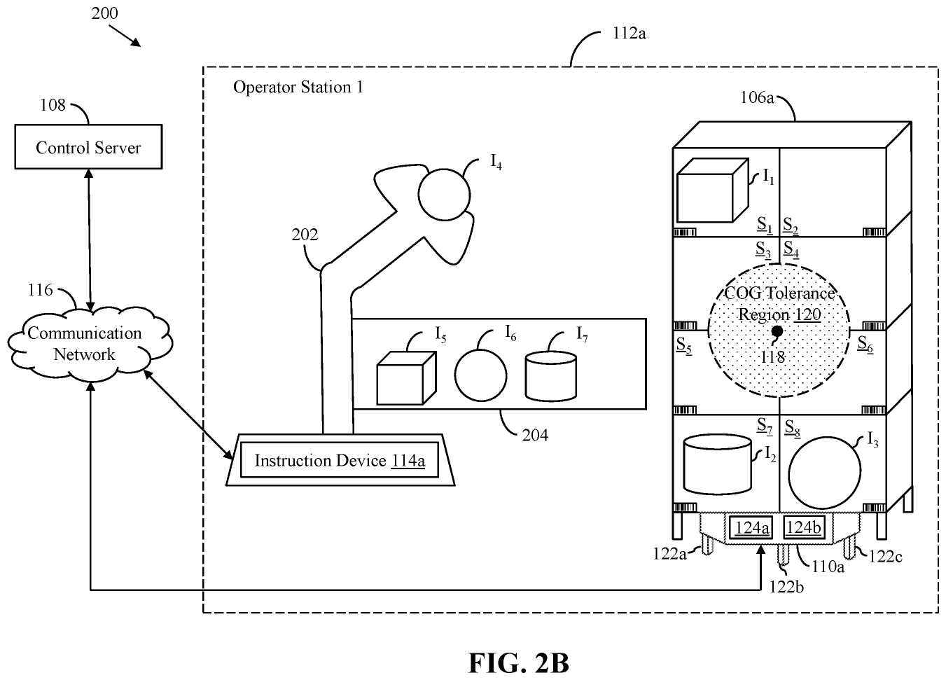

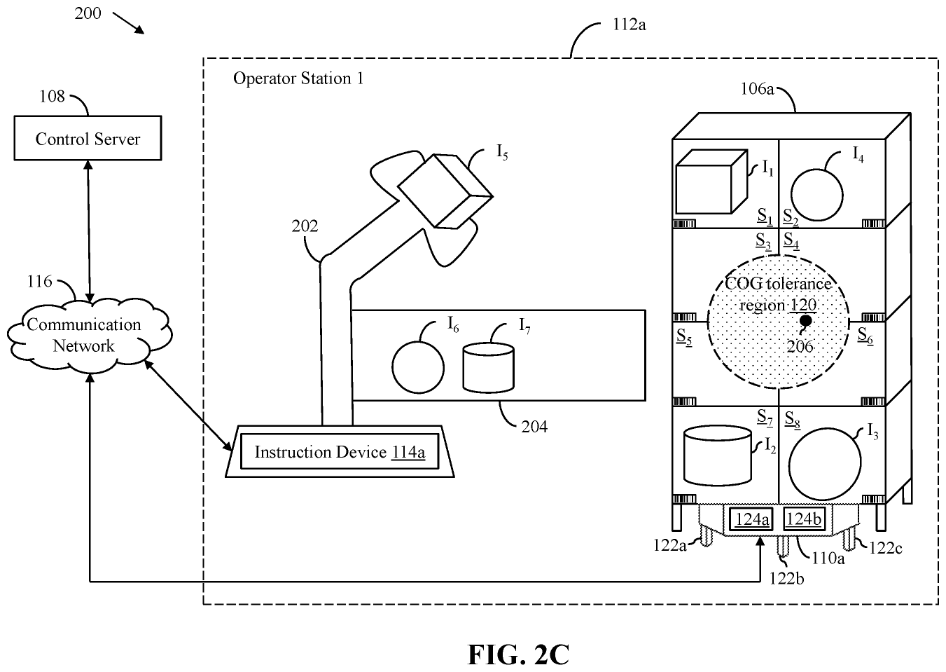

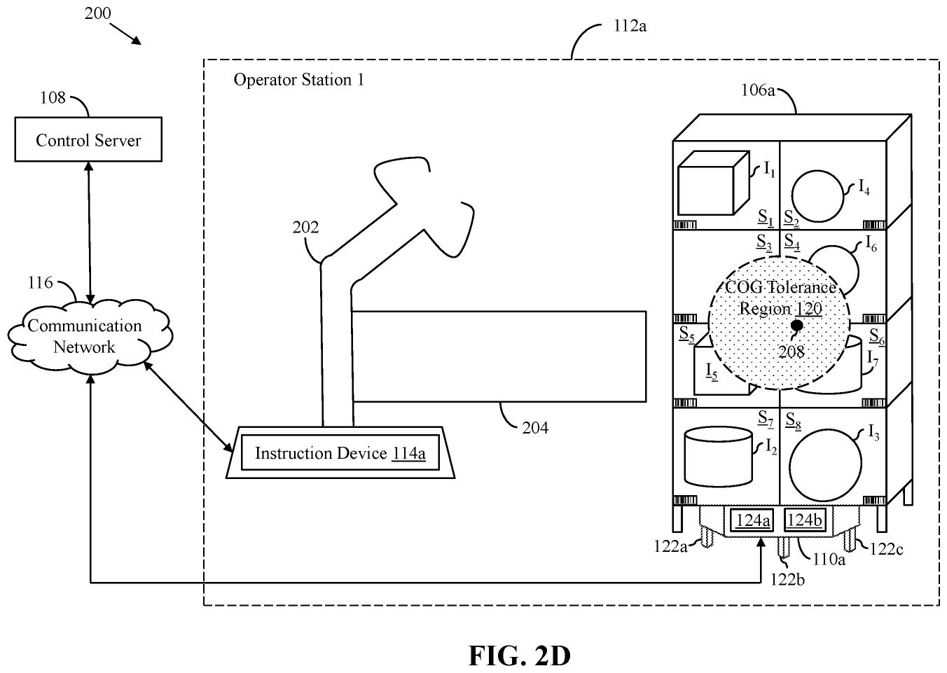

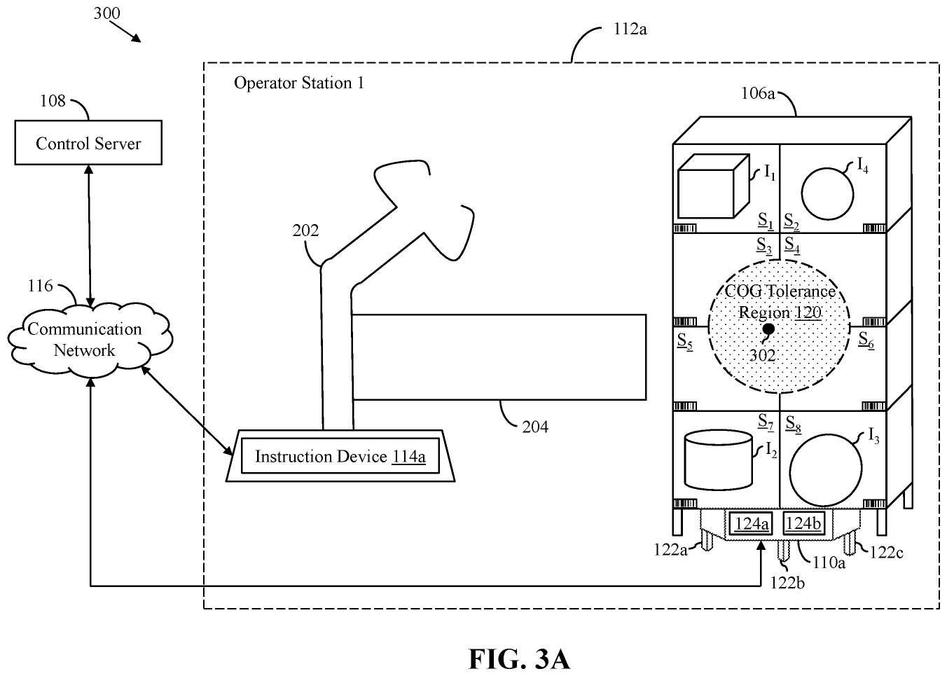

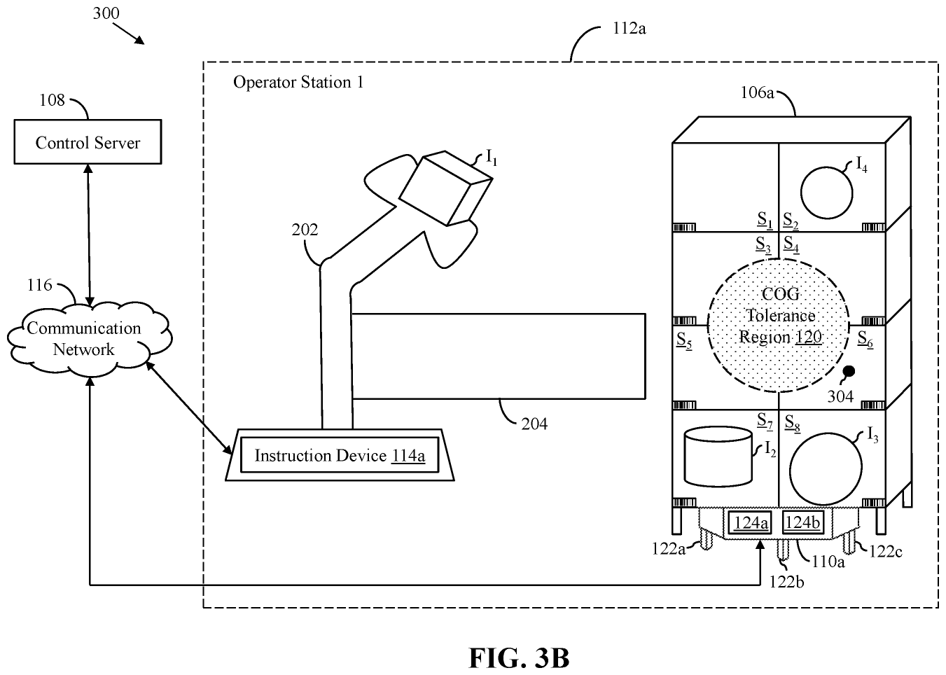

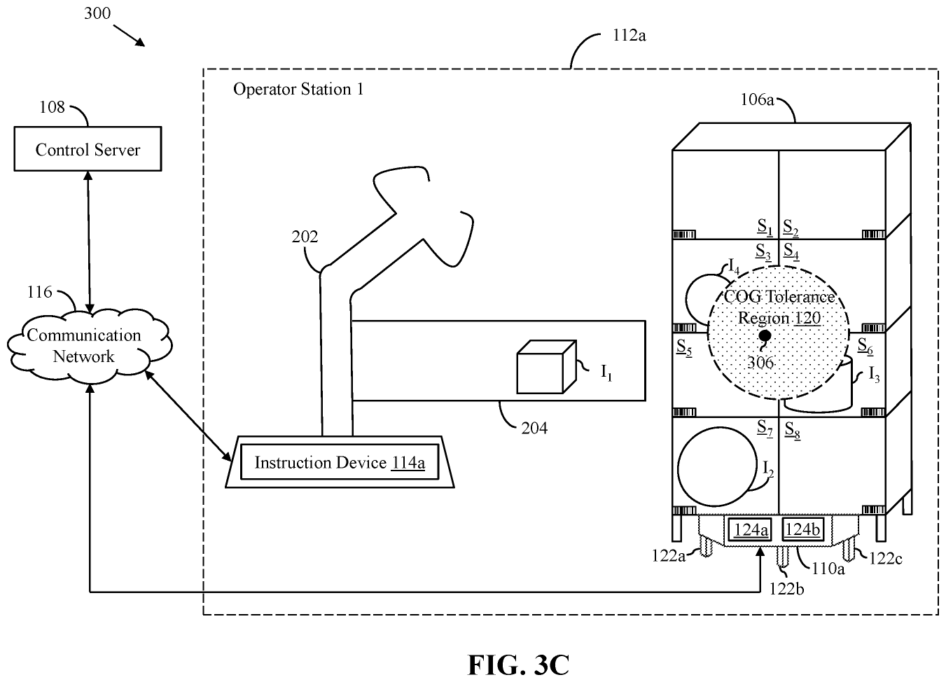

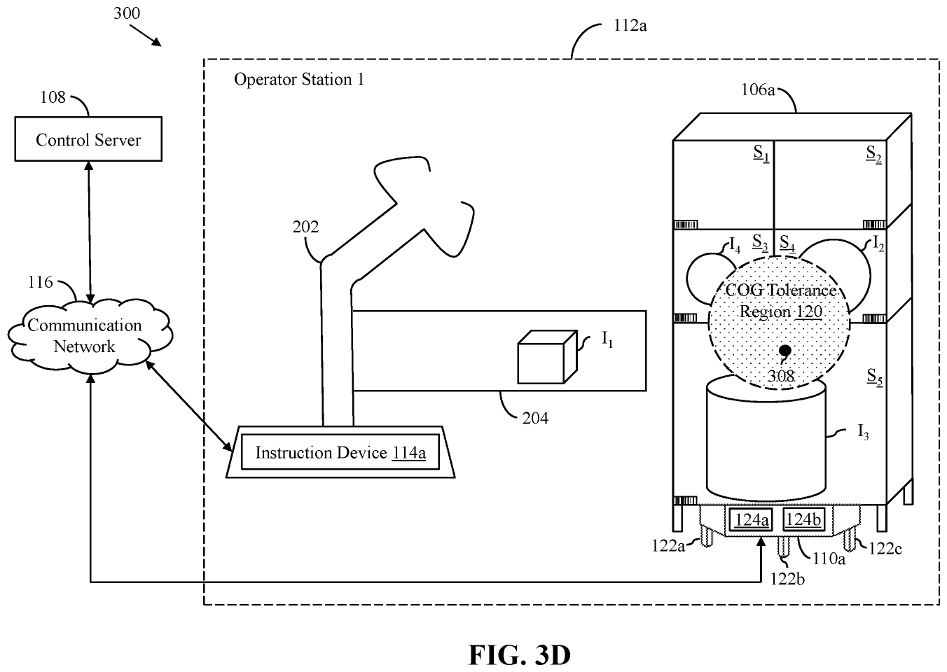

The control server 108 further communicates pick instructions and placement instructions to the instruction devices 114 for facilitating item retrieval from the storage units 106 and item placement in the storage units 106, respectively. The operations performed by the control server 108 for maintaining the COGs of the storage units 106 during item placement and item retrieval are explained in conjunction with FIGS. 2A-2D and 3A-3D, respectively.

It will be apparent to a person of ordinary skill in the art that the COG tolerance region 120 is shown for illustrative purpose and should not be construed to limit the scope of the invention. In another embodiment, the COG tolerance region 120 may have a triangular shape, a rectangular shape, or any other shape without deviating from the scope of the invention.

The transport vehicles 110 may include suitable logic, circuitry, interfaces, and/or codes, executable by the circuitry, to execute various operations for transporting the storage units 106 from the storage area 104 to the operator stations 112 or vice versa. Examples of the transport vehicles 110 may include, but is not limited to, transportation robots, robotic vehicles, transport trolleys, or the like. The transport vehicles 110 receive move instructions from the control server 108. Based on the move instructions, the transport vehicles 110 traverse corresponding optimal paths in the storage facility 102. For example, in FIG. 1, the first transport vehicle 110a is shown to be transporting the first storage unit 106a from the food department D₁ to the first operator station 112a based on a move instruction. The transport vehicles 110 further communicate corresponding real-time locations to the control server 108. The transport vehicles 110 may communicate with the control server 108 via the communication network 116 by using various wired, wireless, or optical communication protocols.

In one embodiment, each transport vehicle 110 includes a lifting mechanism (not shown) and a movement mechanism. For example, the first transport vehicle 110a includes first through third wheels 122a-122c as the movement mechanism. Hereinafter, the movement mechanism is referred to and designated as the “movement mechanism 122”. The lifting mechanism enables each transport vehicle 110 to lift the storage units 106 for transportation and the movement mechanism 122 enables each transport vehicle 110 to move from one location to other in the storage facility 102. The lifting mechanism and the movement mechanism 122 in each transport vehicle 110 may be powered by respective first and second sets of motors (not shown). For example, the first and second sets of motors may supply appropriate current to the lifting mechanism and the movement mechanism 122, respectively, for functioning. The amount of current supplied by the first and second sets of motors to the lifting mechanism and the movement mechanism 122, respectively, may be dependent on a weight of the storage unit that is to be lifted and transported by the corresponding transport vehicle 110. For example, the amount of current supplied by the first and second sets of motors to the lifting mechanism and the movement mechanism 122, respectively, of the first transport vehicle 110a may be dependent on the weight of the first storage unit 106a that is lifted and transported by the first transport vehicle 110a.

Each transport vehicle 110 may further include first and second sets of weighers 124a and 124b attached to the lifting mechanism and the movement mechanism 122, respectively. In one example, the first and second sets of weighers 124a and 124b are current sensors that are configured to measure the amount of current supplied to the lifting mechanism and the movement mechanism 122, respectively, in the corresponding transport vehicle 110. For example, when the lifting mechanism of the first transport vehicle 110a lifts the first storage unit 106a, the first set of weighers 124a attached to the lifting mechanism of the first transport vehicle 110a may measure the amount of current supplied to the lifting mechanism by the first set of motors. Likewise, when the first storage unit 106s is lifted by the first transport vehicle 110a, the first transport vehicle 110a may start moving from one location to another location by way of the corresponding movement mechanism 122. In such a scenario, the second set of weighers 124b that is attached to the movement mechanism 122 of the first transport vehicle 110a may measure the amount of current supplied to the movement mechanism 122 by the second set of motors. The second set of motors may not supply any current to the movement mechanism 122 when the first transport vehicle 110a is at rest. Thus, the second set of weighers 124b may measure the amount of current supplied to the movement mechanism 122 by the second set of motors only when the first transport vehicle 110a is in motion.

Information pertaining to the amounts of current measured by the first and second weighers 124a and 124b may be communicated to the control server 108 by the first transport vehicle 110a, and the control server 108 may determine a weight distribution profile of the first storage unit 106a by utilizing the received information. The control server 108 may further utilize the determined weight distribution profile of the first storage unit 106a to determine that the COG of the first storage unit 106a is at the first position 118 that is within the COG tolerance region 120.

The operator stations 112 in the storage facility 102 may be places where the items are placed in the storage units 106 and/or retrieved from the storage units 106. The operator stations 112 include the instruction devices 114 and various operators (shown in FIGS. 2A-2D, 3A-3D, and 4). The instruction devices 114 communicate with the control server 108 by way of the communication network 116. The instruction devices 114 receive the placement instructions, the pick instructions, and/or rearrangement instructions from the control server 108.

The communication network 116 is a medium through which content and messages are transmitted between the control server 108, the transport vehicles 110, and the instruction devices 114. Examples of the communication network 116 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the storage facility 102 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIGS. 2A-2D are block diagrams that collectively illustrate an exemplary scenario 200 for maintaining the COGs of the storage units 106, in accordance with an embodiment of the present invention. The exemplary scenario 200 involves the control server 108 and the communication network 116.

The control server 108 receives a first request for fulfilling fourth through seventh items I₄-I₇ in the storage facility 102. Based on the first request, the control server 108 identifies one or more departments in the storage area 104 that correspond to the fourth through seventh items I₄-I₇. For example, when the fourth through seventh items I₄-I₇ are food items, the control server 108 may identify that the food department D₁ corresponds to the first request. The control server 108 then identifies one or more storage units in the identified departments that are associated with the fourth through seventh items I₄-I₇. The control server 108 may refer to inventory storage data for identifying the one or more storage units. The inventory storage data may be stored in a memory of the control server 108 and is indicative of the items that are already stored in the storage units 106 and an association between item categories and the storage units 106. In one example, the control server 108 may refer to the inventory storage data to identify that the first and second storage units 106a and 106b in the food department D₁ are associated with the fourth through seventh items I₄-I₇ as the first and second storage units 106a and 106b are allocated to item categories of the fourth through seventh items I₄-I₇.

After the identification of the first and second storage units 106a and 106b, the control server 108 determines the COG tolerance region 120 for the first storage unit 106a and a COG tolerance region for the second storage unit 106b. The control server 108 may determine the COG tolerance region 120 based on a size of the first storage unit 106a, dimensions of the first storage unit 106a, a shape of the first storage unit 106a, a configuration of the first storage unit 106a, a weight of the first storage unit 106a when empty, or the weight distribution profile of the first storage unit 106a. The determination of the weight distribution profile has been described in the foregoing description of FIG. 1. The control server 108 may further determine the COG tolerance region 120 based on types of materials used for making the first storage unit 106a. For example, the COG tolerance region 120 may be different when the first storage unit 106a is made of steel as compared to when the first storage unit 106a is made of iron. The control server 108 may further determine the COG tolerance region 120 based on a risk factor defined by the warehouse management authority. For example, the COG tolerance region 120 may be smaller when the risk factor is 20% as compared to when the risk factor is 40%. As acceleration and deceleration profiles and the lifting mechanisms of the transport vehicles 110, used for transporting the first storage unit 106a, may affect a force that acts upon the first storage unit 106a during transportation, the control server 108 may determine the COG tolerance region 120 based on the acceleration and deceleration profiles and the lifting mechanism of the transport vehicles 110. The control server 108 determines the COG tolerance region for the second storage unit 106b based on a size of the second storage unit 106b, dimensions of the second storage unit 106b, a shape of the second storage unit 106b, a configuration of the second storage unit 106b, a weight of the second storage unit 106b when empty, a weight distribution profile of the second storage unit 106b. The control server 108 may further determine the COG tolerance region of the second storage unit 106b based on types of materials used for making the second storage unit 106b, the risk factor defined by the warehouse management authority, the acceleration and deceleration profiles, and the lifting mechanism of the transport vehicles 110, or the like.

After the COG tolerance region 120 is determined, the control server 108 then selects a storage unit that is optimal for fulfilling the first request from the identified storage units 106a and 106b. For example, the control server 108 may determine that the second storage unit 106b does not have any space to accommodate the fourth through seventh items I₄-I₇. Thus, the first storage unit 106a is optimal for fulfilling the first request. In another example, the control server 108 may determine that if the fourth through seventh items I₄-I₇ are placed in the second storage unit 106b, the COG of the second storage unit 106b would shift out of the corresponding COG tolerance region. For example, if the second storage unit 106b already includes other items, it may be determined that based on items that the second storage unit 106b is currently holding, the COG of the second storage unit 106B would be shifted out of the COG tolerance region if items I₄-I₇ are added to the second storage unit 106B. The control server 108 may further determine that if the fourth through seventh items I₄-I₇ are placed in the first storage unit 106a, the COG of the first storage unit 106a would not shift out of the COG tolerance region 120. Thus, the first storage unit 106a is optimal for fulfilling the first request. In another example, the control server 108 may determine that a distance between the COG of the second storage unit 106b and a center of the corresponding COG tolerance region, if the fourth through seventh items I₄-I₇ are placed in the second storage unit 106b, is greater than a distance between the COG of the first storage unit 106a and a center of the corresponding COG tolerance region 120, if the fourth through seventh items I₄-I₇ are placed in the first storage unit 106a. Thus, the first storage unit 106a in this example is optimal for fulfilling the first request. In the continuing description, it is assumed that the control server 108 identifies that the first storage unit 106a is optimal for fulfilling the first request.

After the identification of the first storage unit 106a, the control server 108 may determine real-time locations of the transport vehicles 110 in the storage facility 102 by using location information received from the transport vehicles 110. Based on the real-time locations of the transport vehicles 110, the control server 108 identifies a transport vehicle from the transport vehicles 110 that is available to handle the first request. In one example, the control server 108 may identify that the first transport vehicle 110a is nearest to the first storage unit 106a and available to handle the first request.

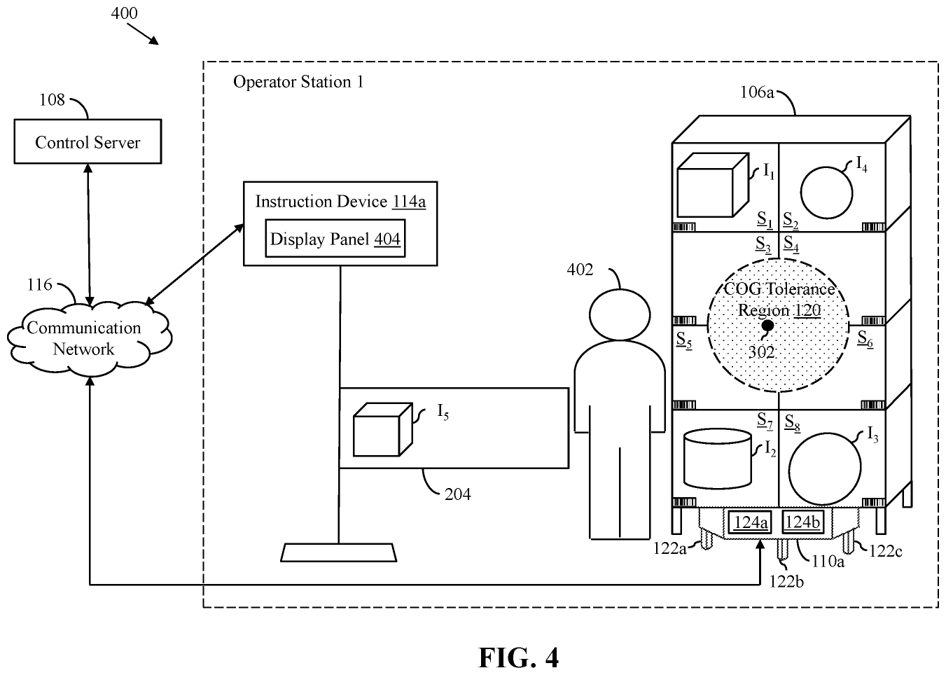

The control server 108 may further select an operator station from the operator stations 112 for handling the first request. In one example, the control server 108 may select the first operator station 112a. The first operator station 112a may include an operator 202 and an item bin 204 where the fourth through seventh items I₄-I₇ are placed. The operator 202 is shown to be an automatic operator, for example, a robotic operator controlled by the first instruction device 114a. The operator 202 may pick the fourth through seventh items I₄-I₇ from the item bin 204 for placement in the first storage unit 106a. In another embodiment, the first operator station 112a may include a human operator (as shown in FIG. 4) instead of the operator 202 without deviating from the scope of the invention. Examples of the item bin 204 may include, but are not limited to, a container, a conveyor belt, a platform, or the like.

The control server 108 then determines a first optimal path in the storage facility 102 that is to be traversed by the first transport vehicle 110a for transporting the first storage unit 106a from the storage area 104 to the first operator station 112a. The control server 108 may determine the first optimal path based on the layout information of the storage facility 102, the real-time locations of other transport vehicles 110b and 110c, or the like. The control server 108 further communicates a first move instruction to the first transport vehicle 110a for traversing along the first optimal path. The first move instruction includes the navigation details of the first optimal path and the details of the first storage unit 106a.

The control server 108 may further identify optimal slots in the first storage unit 106a for storing the fourth through seventh items I₄-I₇. The control server 108 may identify the optimal slots such that when the fourth through seventh items I₄-I₇ are placed in the identified optimal slots, the COG of the first storage unit 106a is maintained within the COG tolerance region 120. For identifying the optimal slots, the control server 108 identifies slots in the first storage unit 106a that are empty or have sufficient space for storing the fourth through seventh items I₄-I₇. The control server 108 may refer to the inventory storage data to identify the slots of the first storage unit 106a that are already occupied and do not have additional space to accommodate more items. For example, based on the inventory storage data, the control server 108 determines that the first, seventh, and eighth slots S₁, S₇, and S₈ of the first storage unit 106a are already fully occupied by various units of the first through third items I₁-I₃, respectively. Thus, the control server 108 identifies that the second through sixth slots S₂-S₆ are available for storing the fourth through seventh items I₄-I₇.

After identifying the available slots S₂-S₆, the control server 108 determines risk scores for the available slots S₂-S₆. A risk score for a slot may be determined based on a set of parameters such as dimensions and configuration of a corresponding storage unit 106, dimensions of the slot, a weight of an item that is to be stored, a type of the item, a shape of the item, dimensions of the item, and/or a number of units of the item. In one embodiment, each parameter may have a corresponding weight assigned to it. Thus, the control server 108 may determine the risk scores for the available slots S₂-S₆ based on a weighted combination of the dimensions of the first storage unit 106a, the dimensions of the available slots S₂-S₆, the weights of the fourth through seventh items I₄-I₇, the type of the fourth through seventh items I₄-I₇, the shapes of the fourth through seventh items I₄-I₇, the dimensions of the fourth through seventh items I₄-I₇ and/or the number of units of the fourth through seventh items I₄-I₇. In one example, the value of the risk score may lie between 0 and 1 such that lower the risk score less risky is the item placement in the corresponding slot.

In one exemplary scenario, the control server 108 determines the risk scores for all possible item-slot pairs, such as {(I₄, S₂), (I₄, S₃), (I₄, S₄), (I₄, S₅), (I₄, S₆), . . . , (I₇, S₆)}. An item-slot pair may have a risk score ‘1’, if the slot is unable to accommodate the corresponding item, i.e., when the dimensions of the slot are not compatible with the dimensions and shape of the item. In one example, the risk score for (I₅, S₅) may be less than the risk score of (I₅, S₂), when the fifth item I₅ is a heavy item and placing the fifth item I₅ in a top slot (i.e., S₂) may shift the COG of the first storage unit 106a out of the COG tolerance region 120. In one embodiment, the control server 108 determines the risk score for an item-slot pair based on a distance between a center (i.e., a best COG position) of the COG tolerance region 120 and a position of the COG attained due to the placement of the item in the corresponding slot. For example, the distance between the center of the COG tolerance region 120 and the position of the COG attained due to the placement of the fourth item I₄ in the second slot S₂ may be less than the distance between the center of the COG tolerance region 120 and the position of the COG attained due to the placement of the fourth item I₄ in the third slot S₃. In this scenario, the risk score for (I₄, S₂) may be less than the risk score for (I₄, S₃). In one embodiment, the control server 108 may take into consideration moving weights of the fourth through seventh items I₄-I₇, while determining the risk scores. For example, the sixth item I₆ is spherical in shape, thus, when placed in the first storage unit 106a, the sixth item I₆ may move and get displaced due to its spherical shape. The displacement of the sixth item I₆ may alter the weight distribution profile of the first storage unit 106a. Thus, the control server 108 preemptively takes into consideration the alteration that may be caused by the displacement of the sixth item I₆, while determining the risk scores. If the risk score for (I₄, S₂) is less than the risk score of (I₄, S₃), the control server 108 may consider the second slot S₂ to be a better placement option for the fourth item I₄ in comparison to the third slot S₃.

After determining the risk scores for all the item-slot pairs, the control server 108 selects a combination of item-slot pairs for which the sum of the risk scores is minimum. For example, the control server 108 may select (I₄, S₂), (I₅, S₅), (I₆, S₄), and (I₇, S₆) as the sum of the risk scores for (I₄, S₂), (I₅, S₅), (I₆, S₄), and (I₇, S₆) is a minimum. The minimum risk score ensures that when the fourth through seventh items I₄-I₇ are placed in the second, fifth, fourth, and sixth slots S₂, S₅, S₄, and S₆, respectively, the COG of the first storage unit 106a is maintained within the COG tolerance region 120 and maximum stability is achieved for the first storage unit 106a. The minimum risk score further ensures that the distance between the center of the COG tolerance region 120 and a position of the COG attained due to the placement of the fourth through seventh items I₄-I₇ in the second, fifth, fourth, and sixth slots S₂, S₅, S₄, and S₆, respectively, is less than any other combination of item-slot pairs. Thus, the second, fifth, fourth, and sixth slots S₂, S₅, S₄, and S₆ correspond to the optimal slots S₂, S₅, S₄, and S₆ selected by the control server 108 for placing the fourth through seventh items I₄-I₇, respectively.

After the selection of the optimal slots S₂, S₄, S₅, and S₆, the control server 108 may communicate a first placement instruction to the first instruction device 114a. The first placement instruction may include information pertaining to the fourth item I₄ and the optimal slot S₂ selected by the control server 108 for placing the fourth item I₄. For example, the first placement instruction may include a first identifier that uniquely identifies the optimal slot S₂ and a first item identifier that uniquely identifies the fourth item I₄. Before the placement of the fourth item I₄ in the first storage unit 106a, the COG of the first storage unit 106a is within the COG tolerance region 120 and at the first position 118.

Referring now to FIG. 2B, the first instruction device 114a receives the first placement instruction from the control server 108. Based on the first placement instruction, the operator 202 identifies the fourth item I₄ and picks the fourth item I₄ from the item bin 204. Before the placement of the fourth item I₄ in the first storage unit 106a, the COG of the first storage unit 106a is within the COG tolerance region 120 and at the first position 118. Based on the first identifier included in the first placement instruction, the operator 202 identifies the optimal slot S₂ in the first storage unit 106a. For example, the operator 202 may scan the identifiers of the first through eighth slots S₁-S₈ to identify the optimal slot S₂. In another example, the operator 202 may include an image sensor and may utilize one or more image sensing techniques to confirm the identifiers of the first through eighth slots S₁-S₈ for identifying the optimal slot S₂. After the optimal slot S₂ is identified, the operator 202 may place the fourth item I₄ in the optimal slot S₂. After the fourth item I₄ is placed in the optimal slot S₂, the first instruction device 114a may transmit a first notification to the control server 108 indicating the placement of the fourth item I₄ in the first storage unit 106a. In one example, the first notification may be a visual confirmation message that includes an image of the first storage unit 106a after the fourth item I₄ is placed in the first storage unit 106a. In another example, the first notification may include a scan result of a slot in which the fourth item I₄ is placed. It will be apparent to a person of skill in the art that the first instruction device 114a may transmit the first notification by any other means known in the art without deviating from the scope of the invention.

In one embodiment, the first notification may indicate that the fourth item I₄ is placed in the optimal slot S₂. In another embodiment, the first notification may indicate that the fourth item I₄ is placed in another slot (e.g., the fifth slot S₅) that is different from the optimal slot S₂. The first notification may further indicate a reason (for example, lack of space, difficulty in placement, a package size of the fourth item I₄ is different from what is perceived by the control server 108, or the like) for not placing the fourth item I₄ in the optimal slot S₂. In such a scenario where the first notification indicates that the fourth item I₄ is not placed in the optimal slot S₂ and the control server 108 determines that COG of the first storage unit 106a has shifted out of the COG tolerance region 120 due to the placement of the fourth item I₄ in the fifth slot S₅, the control server 108 may generate a response corresponding to the first notification. The response is generated to notify the operator 202 to remove the fourth item I₄ from the fifth slot S₅ and place it in a new optimal slot determined by the control server 108. After the fourth item I₄ is successfully placed in the optimal slot S₂, the control server 108 may communicate a second placement instruction to the first instruction device 114a. The second placement instruction may include information pertaining to the fifth item I₅ and the optimal slot S₅ selected by the control server 108 for placing the fifth item I₅. For example, the second placement instruction includes a second identifier that uniquely identifies the optimal slot S₅.

Referring now to FIG. 2C, the fourth item I₄ is shown to be placed in the optimal slot S₂. After the fourth item I₄ is placed in the optimal slot S₂, the COG of the first storage unit 106a shifts from the first position 118 to a second position 206. The shifting of the COG to the second position 206 is due to the placement of the fourth item I₄ in the optimal slot S₂. The placement of the fourth item I₄ in the optimal slot S₂ alters the weight distribution profile of the first storage unit 106a, which results in the shifting of the COG to the second position 206. The operator 202 picks the next item, i.e., the fifth item I₅, from the item bin 204 based on the second placement instruction.

Referring now to FIG. 2D, the operator 202 further places the sixth and seventh items I₆ and I₇ in the optimal slots S₄ and S₆, respectively, based on third and fourth placement instructions received from the control server 108. After the placement of the fourth through seventh items I₄-I₇, the COG of the first storage unit 106a shifts to a third position 208. The third position 208 of the COG is within the COG tolerance region 120 as the fourth through seventh items I₄-I₇ are placed in the optimal slots S₂, S₅, S₄, and S₆ selected by the control server 108.

In another embodiment, the control server 108 may determine the optimal slots for the fourth through seventh items I₄-I₇ separately, i.e., one item at a time. In such a scenario, the control server 108 selects an optimal slot to place the fifth item I₅ after the fourth item I₄ is placed in a corresponding optimal slot of the first storage unit 106a. This process may be repeated until all items are placed. In another embodiment, the operator 202 may reject one or more of the fourth through seventh items I₄-I₇ due to various reasons, for example, damaged inventory. In such a scenario, the control server 108 may select new optimal slots for remaining items of the fourth through seventh items I₄-I₇ in real-time.

In one exemplary scenario, the control server 108 may be unable to select the optimal slots for the placement of the fourth through seventh items I₄-I₇, as the COG shifts out of the COG tolerance region 120 for all combinations of the empty slots S₂-S₆. In such a scenario, the control server 108 may identify new slots for rearranging one or more of the first through third items I₁-I₃ along with selecting optimal slots for placing the fourth through seventh items I₄-I₇. The identification of the new slots for rearranging the first through third items I₁-I₃ is explained in conjunction with FIGS. 3A-3D, which is described in further detail below.

In another embodiment, the COG tolerance region 120 may be segregated into multiple sub-regions, for example, a best sub-region and a good sub-region. In such a scenario, the control server 108 may select the optimal slots for placing the fourth through seventh items I₄-I₇ such that the COG of the first storage unit 106a tends towards the best sub-region. In one embodiment, the control server 108 may not only maintain the COG of the first storage unit 106a within the COG tolerance region 120 but may also optimize warehouse operational parameters, such as a space utilization factor, a throughput, fatigue reduction, ease of placing in and picking items from the first storage unit 106a, or the like. For example, the control server 108 may select those optimal slots for placing the fourth through seventh items I₄-I₇ for which the COG of the first storage unit 106a is maintained within the COG tolerance region 120 and the space utilization factor is optimized. In some examples, the COG tolerance region 120 may be divided into equally sized sub-regions. In other examples, the COG tolerance region 120 may be divided into sub-regions of different sizes.

It will be apparent to a person of ordinary skill in the art that the positions of the COG are shown for illustrative purpose and does not limit the scope of the invention. Also, the shapes of the items are shown only to illustrate the exemplary scenario and can be assumed to be of any shape, size, or volume, without deviating from the scope of the invention.

It will be apparent to a person of ordinary skill in the art that the scope of the invention is not limited to placing the fourth through seventh items I₄-I₇ in the first storage unit 106a at the same operator station, i.e., the first operator station 112a. In another embodiment, the fourth and fifth items I₄ and I₅ may be placed in the first storage unit 106a at the first operator station 112a by the operator 202 and the sixth and seventh items I₆ and I₇ may be placed in the first storage unit 106a at the second operator station 112b by another operator (not shown). In this scenario, the control server 108 may communicate the first and second placement instructions to the first instruction device 114a and the third and fourth placement instructions to the second instruction device 114b.

In another embodiment, it may not be possible to place all the items of the first request in a single storage unit. In such a scenario, the control server 108 may identify multiple storage units for placing the items (for example, the fourth through seventh items I₄-I₇) of the first request. The control server 108 further maintains the COG of each identified storage unit within the corresponding COG tolerance region as described in the foregoing. For example, it may be possible to place the fourth and fifth items I₄ and I₅ in the first storage unit 106a and may not be possible to place the sixth and seventh items I₆ and I₇ in the first storage unit 106a, for example, due to lack of available slots. In such a scenario, the control server 108 identifies another storage unit (for example, the second storage unit 106b) to place the sixth and seventh items I₆ and I₇ and maintains the COG of the first and second storage units 106a and 106b within the corresponding COG tolerance regions.

FIGS. 3A-3D are block diagrams that collectively illustrate another exemplary scenario 300 for maintaining the COGs of the storage units 106, in accordance with an embodiment of the present invention. The exemplary scenario 300 involves the control server 108 and the communication network 116.

The control server 108 receives a second request for retrieving the first item I₁ from the storage facility 102. Based on the second request and the inventory storage data, the control server 108 identifies that the food department D₁ corresponds to the second request and that the first item I₁ is stored in the first and second storage units 106a and 106b of the food department D₁. After the identification of the first and second storage units 106a and 106b, the control server 108 determines the COG tolerance region 120 for the first storage unit 106a and the COG tolerance region for the second storage unit 106b (as described in FIG. 2A). The control server 108 then selects a storage unit that is optimal for fulfilling the second request from the identified storage units 106a and 106b. For example, the control server 108 may determine that the second storage unit 106b does not have required number of units of the first item I₁ and the first storage unit 106a has the required number of units of the first item I₁. Thus, the first storage unit 106a is optimal for fulfilling the second request. In another example, the control server 108 may determine that a distance between the COG of the second storage unit 106b and the center of the corresponding COG tolerance region, if the first item I₁ is picked from the second storage unit 106b, is greater than a distance between the COG of the first storage unit 106a and the center of the corresponding COG tolerance region 120, if the first item I₁ is picked from the first storage unit 106a. Thus, the first storage unit 106a is optimal for fulfilling the second request. In the continuing description, it is assumed that the control server 108 identifies that the first storage unit 106a is optimal for fulfilling the second request.

The control server 108 may then identify a transport vehicle from the transport vehicles 110 that is available to handle the second request based on the real-time locations of the transport vehicles 110. In one example, the control server 108 may identify that the first transport vehicle 110a is nearest to the first storage unit 106a and available to handle the second request. The control server 108 may further select an operator station from the operator stations 112 to handle the second request. In one example, the control server 108 may select the first operator station 112a. The first operator station 112a may include the operator 202, the item bin 204 where the retrieved items are to be placed.

The control server 108 may then determine a second optimal path in the storage facility 102 that is to be followed by the first transport vehicle 110a for transporting the first storage unit 106a from the storage area 104 to the first operator station 112a. The control server 108 may determine the second optimal path as described in FIG. 2. The control server 108 may further communicate a second move instruction to the first transport vehicle 110a for traversing along the second optimal path. The second move instruction may include the navigation details (for example, a navigation map) of the second optimal path and the details of the first storage unit 106a.

As shown in FIG. 3A, before the first item I₁ is picked from the first slot S₁, the COG of the first storage unit 106a is at a fourth position 302. The control server 108 determines whether picking the first item I₁ from the first slot S₁ of the first storage unit 106a would shift the COG of the first storage unit 106a out of the COG tolerance region 120. For determining whether the COG of the first storage unit 106a would out of the COG tolerance region 120, the control server 108 determines a position that may be attained by the COG of the first storage unit 106a after the first item I₁ is picked from the first slot S₁. For determining the position that may be attained by the COG, the control server 108 refers the inventory storage data to retrieve storage unit information of the first storage unit 106a and item information of the second through fourth items I₂-I₄ remaining in the first storage unit 106a after the first item I₁ is picked from the first slot S₁. The storage unit information includes the size of the first storage unit 106a, the dimensions of the first storage unit 106a, the shape of the first storage unit 106a, the configuration of the first storage unit 106a, and the weight of the first storage unit 106a. The item information includes the weights, the types, the shapes, and the dimensions of the second through fourth items I₂-I₄. The control server 108 then determines the position that may be attained by the COG by using the retrieved storage unit information and the retrieved item information.

In one embodiment, the control server 108 determines that the position attained by the COG of the first storage unit 106a, after the first item I₁ is picked, is out of the COG tolerance region 120. The control server 108 then identifies optimal slots from the first through eighth slots S₁-S₈ in the first storage unit 106a for rearranging one or more of the second through fourth items I₂-I₄. The control server 108 identifies the optimal slots such that when one or more of the second through fourth items I₂-I₄ are placed in the identified optimal slots, the COG of the first storage unit 106a is maintained within the COG tolerance region 120. In one embodiment, the control server 108 targets a minimum possible rearrangement for the second through fourth items I₂-I₄. The minimum possible rearrangement may refer to identifying the minimum number of moves required for returning the COG to the COG tolerance region 120. For example, the control server 108 may only rearrange a position of a single item. In the continuing description, it is assumed that the minimum rearrangement includes rearranging the second through fourth items I₂-I₄.

In some embodiments, the control server 108 determines risk scores for the first through eighth slots S₁-S₈. The risk score for a slot may be determined based on dimensions of a corresponding storage unit, dimensions of the slot, a weight of an item that is to be stored, a type of the item, a shape of the item, and/or dimensions of the item. In one embodiment, the control server 108 may determine the risk scores for the first through eighth slots S₁-S₈ based on a weighted combination of the dimensions of the first storage unit 106a, the dimensions of the first through eighth slots S₁-S₈, the weights of the second through fourth items I₂-I₄, the type of the second through fourth items I₂-I₄, the shapes of the second through fourth items I₂-I₄, and/or the dimensions of the second through fourth items I₂-I₄. In one exemplary scenario, the control server 108 determines the risk scores for all possible item-slot pairs, such as {(I₂, S₁), (I₂, S₂), (I₂, S₃), . . . , (I₂, S₈), . . . , (I₄, S₈)}, as described in the foregoing description of FIG. 2A.

After determining the risk scores for all the item-slot pairs, the control server 108 may select a combination of item-slot pairs for which the sum of the risk scores is a minimum. For example, the control server 108 may select (I₂, S₇), (I₃, S₆), and (I₄, S₃) as the sum of the risk score for this combination is a minimum, and thus, results in a minimum possible rearrangement for items I₂-I₄. The minimum risk score ensures that when the second through fourth items I₂-I₄ are rearranged in the seventh, sixth, and third slots S₇, S₆, and S₃, respectively, the COG of the first storage unit 106a is maintained within the COG tolerance region 120. The minimum risk score further ensures that the selected combination of item-slot pairs achieves maximum stability for the first storage unit 106a. Thus, the seventh, sixth, and third slots S₇, S₆, and S₃ are identified as the optimal slots S₇, S₆, and S₃ by the control server 108 for rearranging the second through fourth items I₂-I₄, respectively.

After the identification of the optimal slots S₃, S₆, and S₇, the control server 108 may communicate a pick instruction and a rearrangement instruction to the first instruction device 114a. The pick instruction includes information pertaining to the first item I₁ and the first slot S₁ from where the first item I₁ is to be picked. The rearrangement instruction includes information for rearranging the second through fourth items I₂-I₄ in the seventh, sixth, and third slots S₇, S₆, and S₃, respectively.

Referring now to FIG. 3B, the first instruction device 114a receives the pick instruction and the rearrangement instruction from the control server 108. Based on the pick instruction, the operator 202 identifies the first item I₁ and picks the first item I₁ from the first slot S₁. The picking of the first item I₁ from the first storage unit 106a alters the weight distribution profile of the first storage unit 106a, which results in the shifting of the COG from the fourth position 302 to a fifth position 304. The fifth position 304 of the COG of the first storage unit 106a is out of the COG tolerance region 120. Based on the rearrangement instruction, the operator 202 identifies the optimal slots S₇, S₆, and S₃ in the first storage unit 106a and rearranges the second through fourth items I₂-I₄ in the optimal slots S₇, S₆, and S₃, respectively.

Referring now to FIG. 3C, after the rearrangement of the second through fourth items I₂-I₄ in the optimal slots S₇, S₆, and S₃, respectively, the COG of the first storage unit 106a shifts to a sixth position 306 from the fifth position 304. The sixth position 306 of the COG is within the COG tolerance region 120 as the second through fourth items I₂-I₄ are placed in the optimal slots S₇, S₆, and S₃, respectively, identified by the control server 108.

In one embodiment, after the second through fourth items I₂-I₄ are rearranged in the seventh, sixth, and third slots S₇, S₆, and S₃, respectively, the first instruction device 114a may transmit a second notification to the control server 108 indicating the rearrangement of the second through fourth items I₂-I₄ in the seventh, sixth, and third slots S₇, S₆, and S₃, respectively. In one example, the second notification may be a visual confirmation message that includes an image of the first storage unit 106a after the first item I₁ is picked from the first storage unit 106a. In another example, the second notification may include a scan result of a slot from which the first item I₁ is picked. It will be apparent to a person of skill in the art that the first instruction device 114a may transmit the second notification by any other means known in the art without deviating from the scope of the invention. In one embodiment, the second notification may indicate that the second through fourth items I₂-I₄ are placed in the optimal slots S₇, S₆, and S₃, respectively. In another embodiment, the second notification may indicate that the second through fourth items I₂-I₄ are placed in other slots that are different from the selected slots S₇, S₆, and S₃. The second notification may further indicate a reason (for example, lack of space, difficulty in placement, package sizes of the second through fourth items I₂-I₄ are different from what is perceived by the control server 108, or the like) for not placing the second through fourth items I₂-I₄ in the optimal slots S₇, S₆, and S₃, respectively. In such a scenario where the second notification indicates that the second through fourth items I₂-I₄ are not rearranged in the optimal slots S₇, S₆, and S₃, respectively, and the control server 108 determines that COG of the first storage unit 106a has shifted out of the COG tolerance region 120 due to the wrong placement of the second through fourth items I₂-I₄, the control server 108 may generate a response corresponding to the second notification. The response is generated to notify the operator 202 to rearrange the second through fourth items I₂-I₄ in new optimal slots determined by the control server 108.

Referring now to FIG. 3D, in another embodiment, the control server 108 may be unable to select the optimal slots for the rearranging the second through fourth items I₂-I₄, as the COG shifts out of the COG tolerance region 120 for all combinations of the item-slot pairs. In such a scenario, the control server 108 may dynamically adjust the dimensions of the first through eighth slots S₁-S₈ in the first storage unit 106a for rearranging the second through fourth items I₂-I₄. As shown in FIG. 3D, the second and fourth items I₂ and I₄ are placed in the third and fourth slots S₃ and S₄, and the size of the fifth slot S₅ is increased to occupy the space of sixth through eighth slots S₆-S₈. The third item I₃ is stored in the modified fifth slot S₅.

It will be apparent to a person of ordinary skill in the art that the scope of the invention is not limited to performing item placement and retrieval separately, as shown in FIGS. 2A-2D and 3A-3D. In another embodiment, the control server 108 is capable of managing the COG of the first storage unit 106a for parallel placement and retrieval operations. In such a scenario, the control server 108 performs the operations illustrated in FIGS. 2A-2D and 3A-3D in parallel, without deviating from the scope of invention. In one exemplary scenario, the control server 108 may receive the first and second requests at the same time, thus, the control server 108 selects optimal slots in the first storage unit 106a for placing the fourth through seventh items I₄-I₇ after the first item I₁ is picked from the first storage unit 106a. The control server 108 may further identify optimal slots for rearranging one or more of the second and third items I₂ and I₃, when no combination of the item-slot pairs is suitable for placing the fourth through seventh items I₄-I₇ in the first storage unit 106a. In another exemplary scenario, the control server 108 may receive multiple requests for item placement or item retrieval at the same time. In such a scenario, the control server 108 may be configured to determine a sequence to handle the requests while maintaining the COGs of the storage units 106 within the corresponding COG tolerance regions.

In another embodiment, the first item I₁ specified in the second request may be stored in multiple slots of the first storage unit 106a. In such a scenario, the control server 108 may select an optimal slot for picking the first item I₁. The control server 108 may select the optimal slot for picking the first item I₁ such that the COG of the first storage unit 106a does not shift out of the COG tolerance region 120 of the first storage unit 106a. In one exemplary scenario, the control server 108 may not be able to select any optimal slot from the slots in the first storage unit 106a that store the first item I₁. In such a scenario, the control server 108 may select a slot for picking the first item I₁, such that when the first item I₁ is picked from the selected slot the distance between the COG of the first storage unit 106a and the center of the COG tolerance region 120 is least as compared to picking the first item I₁ from the other slots.

In another embodiment, if the control server 108 receives a request for retrieving multiple items from the storage facility 102, but the control server 108 determines that it may not be possible to pick all the items of the request from a single storage unit. In such a scenario, the control server 108 may identify multiple storage units for picking the items (for example, first through fourth items I₁-I₄) of the request. The control server 108 further maintains the COG of each identified storage unit within the corresponding COG tolerance region as described in the foregoing. For example, it may be possible to pick the first and second items I₁ and I₂, respectively, from the first storage unit 106a and may not be possible to pick the third and fourth items I₃ and I₄, respectively, from the first storage unit 106a, for example, due to unavailability of the third and fourth items I₃ and I₄, respectively. In such a scenario, the control server 108 may identify another storage unit (for example, the second storage unit 106b) to pick the third and fourth items I₃ and I₄, respectively, and maintains the COG of the first and second storage units 106a and 106b within the corresponding COG tolerance regions.

In one embodiment, the control server 108 may be configured to predict upcoming requests based on historical request data stored in its memory. For example, the control server 108 may use a time series forecasting algorithm, a machine learning algorithm, or the like to predict the upcoming requests. Based on the prediction of the upcoming requests, the control server 108 may further predict future item placement and retrieval operations associated with the upcoming requests. The control server 108 may further select the optimal slots for the current request by taking into consideration the future item placement and retrieval operations. For example, the control server 108 may identify two optimal slots (i.e., the second slot S₂ and the fifth slot S₅) for placing the fourth item I₄ of the current request in the first storage unit 106a. The control server 108 may further predict that after two hours, another request for placing an eighth item may be received, and the eighth item may be placed in the first storage unit 106a. In such a scenario, the control server 108 may select one slot from the second and fifth slots S₂ and S₅ for placing the fourth item I₄ such that the eighth item can also be placed in the first storage unit 106a after two hours without causing the COG of the first storage unit 106a to shift out of the COG tolerance region 120. In other words, the control server 108 not only maintains the COGs of the storage units 106 within the corresponding COG tolerance regions for the current requests, but also takes into consideration the upcoming requests. In one embodiment, the control server 108 may be configured to prioritize the current request over the upcoming requests.

FIG. 4 is a block diagram that illustrates an exemplary scenario 400 for maintaining COGs of the storage units 106, in accordance with an embodiment of the present invention. The exemplary scenario 400 involves the control server 108 and the communication network 116.

The exemplary scenario 400 illustrates a human operator 402. The human operator 402 performs the operations performed by the operator 202 as shown in FIGS. 2A-2D and 3A-3D. The human operator 402 performs the operations based on instructions received by the instruction device 114a. The instruction device 114a includes a display panel 404 for displaying the instructions (for example, the placement instructions, the rearrangement instructions, or the pick instructions) to the human operator 402. The human operator 402 reads the instruction displayed on the display panel 404 and performs the operations (as described in FIGS. 2A-2D and 3A-3D) accordingly. For example, the instruction device 114a communicates the placement instruction for placing the fifth item I₅ in the third slot S₃ of the first storage unit 106a. The human operator 402 thus places the fifth item I₅ in the third slot S₃.

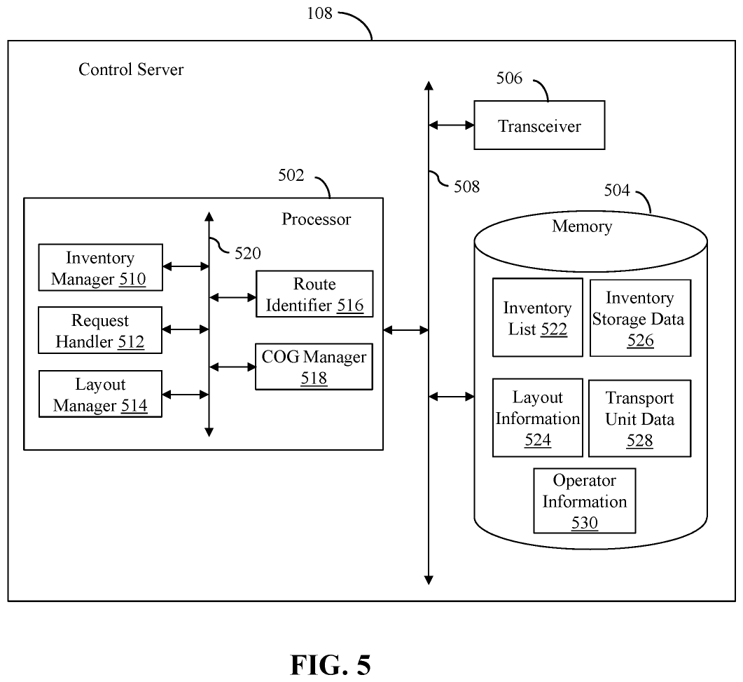

FIG. 5 is a block diagram that illustrates the control server 108, in accordance with an embodiment of the present disclosure. The control server 108 includes a processor 502, a memory 504 (as described in FIGS. 2A-2D), and a transceiver 506 that communicate with each other by way of a first communication bus 508. The processor 502 includes an inventory manager 510, a request handler 512, a layout manager 514, a route identifier 516, and a COG manager 518 that communicate with each other by way of a second communication bus 520. It will be apparent to a person of ordinary skill in the art that the control server 108 is for illustrative purposes and not limited to any specific combination or hardware circuitry and/or software. For example, the control server 108 may be implemented by a server system that includes a plurality of servers each configured to perform one or a combination of the functions of the server. Furthermore, the control server 108 may be implemented by a plurality of devices that are operating over a cloud and communicating with devices in the storage facility via communication network 116.

The processor 502 includes suitable logic, circuitry, interfaces, and/or codes, executed by the circuitry, to execute various operations, such as the inventory management operations, the warehouse management operations, procurement operations, COG maintenance operations, or the like. Examples of the processor 502 include, but are not limited to, an application-specific integrated circuit (ASIC) processor, a reduced instruction set computing (RISC) processor, a complex instruction set computing (CISC) processor, a field-programmable gate array (FPGA), and the like. The processor 502 performs the COG maintenance operations as described in foregoing in FIGS. 2A-2D and 3A-3D.

The memory 504 includes suitable logic, circuitry, interfaces, and/or codes, executed by the circuitry, to store an inventory list 522, layout information 524, inventory storage data 526, transport unit data 528, and operator information 530 (as described in FIGS. 2A-2D and 3A-3D). Examples of the memory 504 include, but are not limited to, a random-access memory (RAM), a read-only memory (ROM), a removable storage drive, a hard disk drive (HDD), a flash memory, a solid-state memory, and the like. In one embodiment, the memory 504 may be realized through various database technologies such as, but not limited to, Microsoft® SQL, Oracle®, IBM DB2®, Microsoft Access®, PostgreSQL®, MySQL® and SQLite®. It will be apparent to a person skilled in the art that the scope of the disclosure is not limited to realizing the memory 504 in the control server 108, as described herein. In other embodiments, the memory 504 may be realized in form of an external database server or a cloud storage working in conjunction with the control server 108, without departing from the scope of the disclosure.

The inventory list 522 may include the list of items stored in the storage facility 102 and the number of units of each item stored in the storage facility 102. The layout information 524 may include information of the layout of the storage facility 102 such as location data of the food and apparels departments D₁ and D₂. The layout information 524 may further include the association item categories and the slots (e.g., the first through eighth slots S₁-S₈). The layout information 524 may further include real-time path availability information of various paths in the storage facility 102. For example, a first path in the storage facility 102 may be under maintenance and hence is unavailable for traversing. Further embodiments for selecting a transportation path are disclosed in U.S. patent application Ser. No. 15/549,324, titled “APPARATUS AND METHOD FOR HANDLING GOODS,” filed on Aug. 7, 2017, the entire contents of which are incorporated herein by reference.

The inventory storage data 526 is indicative of storage locations of the storage units 106 in the storage facility 102 and the items stored in the storage units 106. The inventory storage data 526 further includes the identifiers of the storage units 106. The identifiers are unique codes assigned to each of the storage units 106. In one example, the identifiers are radio frequency identification (RFID) tags that are readable by the transport vehicles 110. Thus, based on the inventory storage data 526, the control server 108 is aware of the locations of all items stored in the storage facility 102. The inventory storage data 526 further includes the storage unit information of the storage units 106 and item information of the items stored in the storage units 106 (as described in the foregoing description of FIG. 3A).

The transport unit data 528 is indicative of details of the transport vehicles 110 available in the storage facility 102. The details of the transport vehicles 110 include capacity, size, and dimension of each transport vehicle 110. The operator information 530 includes details of various operators, such as the operator 202, in the storage facility 102.

The transceiver 506 transmits and receives data over the communication network 116 using one or more communication network protocols. The transceiver 506 transmits various requests and messages to the transport vehicles 110 and the instruction devices 114 and receives requests and messages from the transport vehicles 110 and the instruction devices 114. Examples of the transceiver 506 include, but are not limited to, an antenna, a radio frequency transceiver, a wireless transceiver, a Bluetooth transceiver, an Ethernet based transceiver, a universal serial bus (USB) transceiver, or any other device configured to transmit and receive data.

The processor 502 performs the COG maintenance operations by way of the inventory manager 510, the request handler 512, the layout manager 514, the route identifier 516, and the COG manager 518. The inventory manager 510 manages the inventory list 522 stored in the memory 504. For example, the inventory manager 510 adds new items to the inventory list 522 when the new items are stored in the storage facility 102 and updates the inventory list 522 based on various requests, e.g., the first and second requests.

The request handler 512 processes all the requests received from the external communication system and stores a record (i.e., the historical request data) of all historical requests in the memory 504. In one embodiment, the request handler 512 merges one or more requests to optimize item placement and item retrieval. The layout manager 514 manages the layout information 524. For example, if there is any change in the layout of the storage facility 102 (such as a change in the arrangement of the storage units 106), the layout manager 514 updates the layout information 524 based on the change in the layout. The route identifier 516 is responsible for identifying the optimal routes, e.g., the first and second optimal routes. The COG manager 518 ensures that the COG of all the storage units 106 is maintained within the corresponding COG tolerance regions (as described in FIGS. 2A-2D and 3A-3D). In one embodiment, the manager 518 predicts the upcoming requests and the future item placement and retrieval operations associated with the upcoming requests based on the historical request data stored in the memory 504.

Though, the processor 502 is depicted as a hardware component in FIG. 5, a person skilled in the art will appreciate that the scope of the disclosure is not limited to realizing the processor 502 as the hardware component. In another embodiment, the functionality of the processor 502 may be implemented by way of a computer executable code or a set of computer readable instructions stored in the memory 504, without deviating from the spirit of the disclosure.

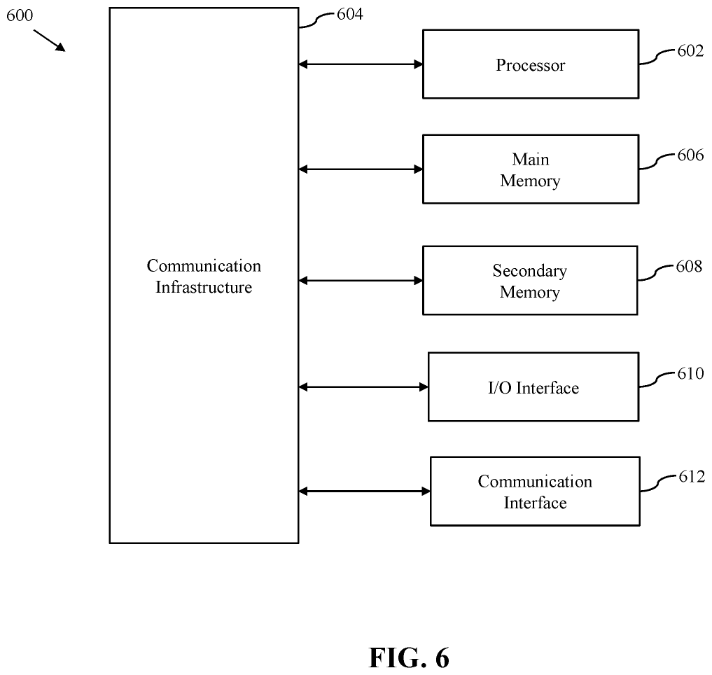

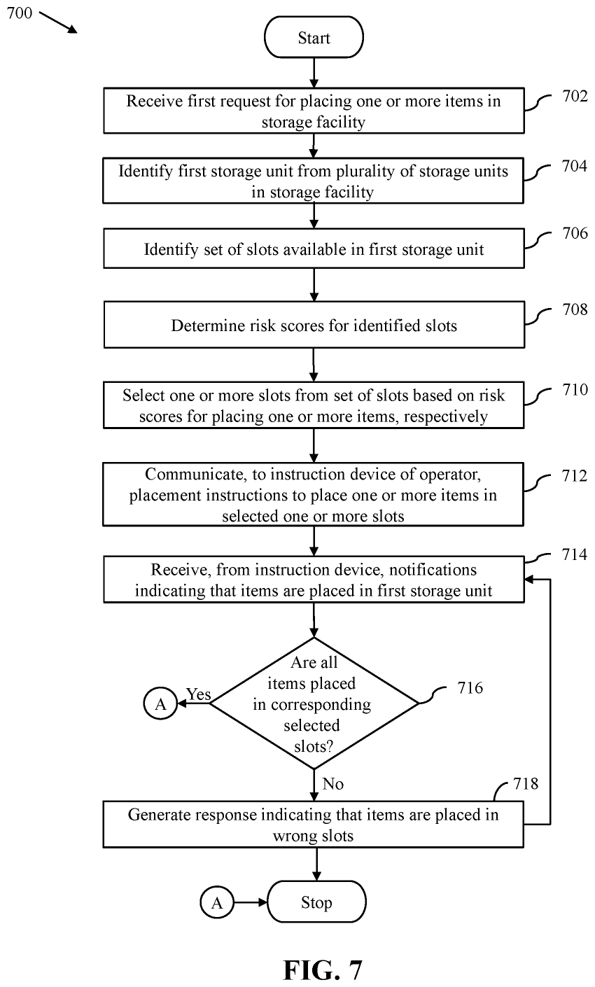

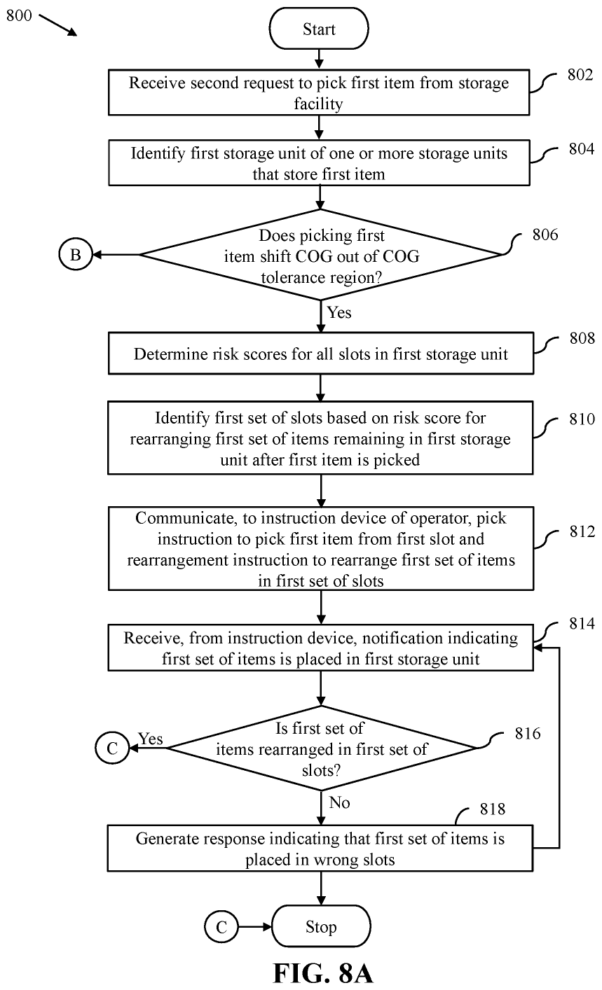

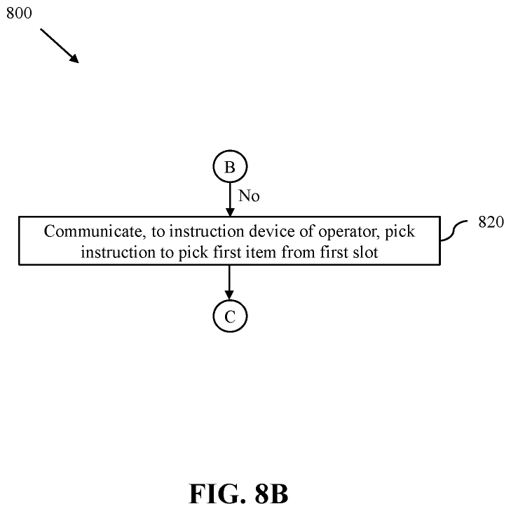

FIG. 6 is a block diagram that illustrates system architecture of a computer system 600, in accordance with an embodiment of the present invention. An embodiment of present invention, or portions thereof, may be implemented as computer readable code on the computer system 600. In one example, the storage facility 102 may be implemented in the computer system 600. Hardware, software, or any combination thereof may embody modules and components used to implement methods of FIGS. 7, 8A, and 8B. The computer system 600 includes a processor 602 that may be connected to a communication infrastructure 604. The computer system 604 may further include a main memory 606 and a secondary memory 608. The computer system 600 further includes an input/output (I/O) interface 610 and a communication interface 612. The communication interface 612 may allow data transfer between the computer system 600 and various devices that are communicatively coupled to the computer system 600.

FIG. 7 is a flow chart 700 that illustrates a process (e.g., method) for maintaining COGs of the storage units 106, in accordance with an embodiment of the present invention. The process may generally start at step 702, where the control server 108 receives a first request for placing one or more items in the storage facility 102. The process proceeds to step 704, where the control server 108 identifies the first storage unit 106a from the plurality of storage units 106 as described in FIG. 2A. The process proceeds to step 706, where the control server 108 identifies a set of slots (e.g., the available slots S₂-S₆) available in the first storage unit 106a for placing the one or more items (e.g., the fourth through seventh items I₄-I₇). The process proceeds to step 708, where the control server 108 determines the risk scores for the identified set of slots (e.g., the available slots S₂-S₆). For an item-slot pair, the risk score may be determined based on the dimensions and configurations of the first storage unit 106a, the dimensions of the slot, the weight of the item, the type of the item, the shape of the item, the number of units of the item, or the dimensions of the item as described in FIG. 2A. The process proceeds to step 710, where the control server 108 selects one or more optimal slots (e.g., the optimal slots S₂, S₅, S₄, and S₆ of FIG. 2A) from the set of slots (e.g., the available slots S₂-S₆) based on the risk scores for placing the one or more items (e.g., the fourth through seventh items I₄-I₇), respectively. The process proceeds to step 712, where the control server 108 communicates placement instructions to the first instruction device 114a for placing the one or more items (e.g., the fourth through seventh items I₄-I₇) in the selected one or more optimal slots (e.g., the optimal slots S₂, S₅, S₄, and S₆). The process proceeds to step 714, where the control server 108 receives, from the first instruction device 114a of the operator 202, notifications indicating that the one or more items (e.g., the fourth through seventh items I₄-I₇) are placed in the first storage unit 106a. The process proceeds to step 716, where the control server 108 determines whether all the items (e.g., the fourth through seventh items I₄-I₇) are placed in the corresponding optimal slots (e.g., the optimal slots S₂, S₅, S₄, and S₆, respectively). If at step 716, it is determined that the items (e.g., the fourth through seventh items I₄-I₇) are not placed in the corresponding optimal slots (e.g., the optimal slots S₂, S₅, S₄, and S₆, respectively) and the COG of the first storage unit 106a has shifted out of the COG tolerance region 120 due to wrong placement, the process proceeds to step 718. At step 718, the control server 108 generates a response indicating that the items (e.g., the fourth through seventh items I₄-I₇) are placed in wrong slots (i.e., different slots from the corresponding optimal slots). The response further indicates new optima slots for the placement of the one or more items (e.g., the fourth through seventh items I₄-I₇). The process returns from step 718 to step 714. If at step 716, it is determined that the items (e.g., the fourth through seventh items I₄-I₇) are placed in the corresponding optimal slots (e.g., the optimal slots S₂, S₅, S₄, and S₆, respectively), no response is generated, and the process proceeds to process A, which proceeds to stop the process illustrated in FIG. 7.

FIGS. 8A and 8B, collectively represent a flow chart 800 that illustrates a process (e.g., method) for maintaining COGs of the storage units 106, in accordance with an embodiment of the present invention.

The process may generally start at step 802, where the control server 108 receives a second request (e.g., the second request of FIG. 3A) to pick the first item I₁ from the storage facility 102. The storage facility 102 includes various storage units (e.g., the first and second storage units 106a and 106b) that store the first item I₁. The process proceeds to step 804, where the control server 108 identifies the first storage unit 106a of the one or more storage units that store the first item I₁ (as described in FIG. 3A). The process proceeds to step 806, where the control server 108 determines whether picking the first item I₁ from the first slot S₁ of the first storage unit 106a would shift the COG of the first storage unit 106a out of the COG tolerance region 120. If at step 806, it is determined that the COG of the first storage unit 106a shifts out of the COG tolerance region 120, the process proceeds to step 808, where the control server 108 determines the risk scores for all the slots (i.e., the first through eighth slots S₁-S₈, in the first storage unit 106a). For an item-slot pair, the risk score is determined based on the dimensions and configurations of the first storage unit 106a, the dimensions of the slot, the weight of the item, the type of the item, the shape of the item, the number of units of the item, or the dimensions of the item as described in FIG. 3A. The process proceeds to step 810, where the control server 108 identifies a first set of slots (for example, the seventh, sixth, and third slots S₇, S₆, and S₃) based on the risk scores for rearranging a first set of items (for example, one or more of the second through fourth items I₂-I₄) remaining in the first storage unit 106a after the first item I₁ is picked. The process proceeds to step 812, where the control server 108 communicates, to the first instruction device 114a of the operator 202, the pick instruction to pick the first item I₁ from the first slot S₁ and the rearrangement instruction to rearrange the first set of items (e.g., one or more of the second through fourth items I₂-I₄) in the first set of slots (e.g., the seventh, sixth, and third slots S₇, S₆, and S₃, respectively).

The process proceeds to step 814, where the control server 108 receives, form the first instruction device 114a of the operator 202, a notification indicating the first set of items (e.g., the second through fourth items I₂-I₄) is placed in the first storage unit 106a. The process proceeds to step 816, where the control server 108 determines whether the first set of items (e.g., the second through fourth items I₂-I₄) is placed in the first set of slots (e.g., the seventh, sixth, and third slots S₇, S₆, and S₃, respectively). If at step 816, it is determined that the first set of items (e.g., the second through fourth items I₂-I₄) is not placed in the first set of slots (e.g., the seventh, sixth, and third slots S₇, S₆, and S₃, respectively), the process proceeds to step 818. At step 818, the control server 108 generates the response indicating that the first set of items (e.g., the second through fourth items I₂-I₄) is placed in the wrong slots and instructs the operator 202 to rearrange the first set of items (e.g., the second through fourth items I₂-I₄) in new set of slots selected by the control server 108. The process returns from step 818 to step 814. If at step 816, it is determined that the first set of items (e.g., the second through fourth items I₂-I₄) is placed in the first set of slots (e.g., the seventh, sixth, and third slots S₇, S₆, and S₃, respectively), the control server 108 stops the process.

If at step 806, it is determined that the COG of the first storage unit 106a does not shift out of the COG tolerance region 120, the process proceeds to step 820, via process B, which is illustrated in FIG. 8B. At step 820, the control server 108 communicates to the first instruction device 114a of the operator 202, the pick instruction to pick the first item I₁ from the first slot S₁. After step 820 is performed, the process illustrated in FIGS. 8A and 8B stops.

Technological improvements in the control server 108 enables the control server 108 to maintain the COGs of the storage units 106 within the corresponding COG tolerance regions while placing items in the storage units 106 or while retrieving items from the storage units 106. Maintaining COGs of the storage units 106 in the corresponding COG tolerance regions prevents toppling of the storage units 106 while transporting the storage units 106 from one place to another in the storage facility 102. Thus, the damage caused to inventory and operators in the storage facility 102 and down time of the storage facility 102, due to toppling of the storage units 106 is reduced, thereby increasing the efficiency of the warehouse management operations. In addition, the control server 108 takes into consideration the acceleration and deacceleration profiles and the lifting mechanism of the transport vehicles 110 while determining the COG tolerance regions of the storage units 106. Thus, the control server 108 may pre-emptively determine upper and lower limits of torque that is to be applied by the transport vehicles 110 for lifting the storage units 106 and upper and lower limits of acceleration and deacceleration rates to be used by the transport vehicles 110 during the transportation of the storage units 106.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for maintaining center of gravity of the storage unit. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for maintaining a center of gravity (COG) of a first storage unit, the method comprising:
receiving, by a server, a first request for placing at least one item in a storage facility that includes a plurality of storage units;
identifying, by the server, the first storage unit from the plurality of storage units for placing the item;
identifying, by the server, a set of slots available in the first storage unit for placing the item;
selecting, by the server, a first slot of the set of slots to place the item such that when the item is placed in the first slot, the COG of the first storage unit is maintained within a COG tolerance region of the first storage unit; and
communicating, by the server to an instruction device associated with an operator, a placement instruction to place the item in the first slot, wherein the item is placed in the first slot by the operator based on the placement instruction.

2. The method of claim 1, further comprising:
determining, by the server, the COG tolerance region of the first storage unit based on at least one of a size of the first storage unit, a first set of dimensions of the first storage unit, a weight of the first storage unit, a shape of the first storage unit, or a configuration of the first storage unit.

3. The method of claim 1, further comprising:
determining, by the server, a risk score for each slot of the set of slots available in the first storage unit before selecting the first slot.

4. The method of claim 3, wherein the risk score for each slot is determined based on at least one of a first set of dimensions of the first storage unit, a second set of dimensions of each slot and at least one of a weight of the item, a type of the item, a shape of the item, or a third set of dimensions of the item.

5. The method of claim 3, wherein the first slot is selected by the server based on the risk score determined for each slot of the set of slots.

6. The method of claim 1, further comprising:
receiving, by the server from the instruction device, a notification indicating that the item is placed in the first slot of the first storage unit.

7. The method of claim 1, further comprising:
receiving, by the server from the instruction device, a notification indicating that the item is placed in a second slot of the set of slots, wherein the second slot is different from the first slot; and
generating, by the server, a response to the notification when the placement of the item in the second slot shifts the COG of the first storage unit out of the COG tolerance region.

8. A system for maintaining a center of gravity (COG) of a first storage unit, the system comprising:
a server that is configured to:
receive a first request for placing at least one item in a storage facility that includes a plurality of storage units,
identify the first storage unit of the plurality of storage units for placing the item,
identify a set of slots available in the first storage unit for placing the item,
select a first slot from the set of slots to place the item such that when the item is placed in the first slot, the COG of the first storage unit is maintained within a COG tolerance region of the first storage unit, and
communicate, to an instruction device associated with an operator, a placement instruction to place the item in the first slot, wherein the item is placed in the first slot by the operator based on the placement instruction.

9. The system of claim 8, wherein the server is further configured to determine the COG tolerance region of the first storage unit based on at least one of a size of the first storage unit, a first set of dimensions of the first storage unit, a weight of the first storage unit, a shape of the first storage unit, or a configuration of the first storage unit.

10. The system of claim 8, wherein the server is further configured to determine a risk score for each slot of the set of slots available in the first storage unit before selecting the first slot.

11. The system of claim 10, wherein the risk score for each slot is determined based on at least one of a first set of dimensions of the first storage unit, a second set of dimensions of each slot and at least one of a weight of the item, a type of the item, a shape of the item, or a third set of dimensions of the item.

12. The system of claim 10, wherein the server selects the first slot based on the risk score determined for each slot of the set of slots.

13. The system of claim 8, wherein the server is further configured to receive, from the instruction device, a notification indicating that the item is placed in the first slot of the first storage unit.

14. The system of claim 13, wherein the server is further configured to:
receive, from the instruction device, a notification indicating that the item is placed in a second slot of the set of slots, wherein the second slot is different from the first slot, and
generate a response to the notification when the placement of the item in the second slot shifts the COG of the first storage unit out of the COG tolerance region.

15. A method for maintaining a center of gravity (COG) of a first storage unit, the method comprising:
receiving, by a server, a first request to pick a first item from a storage facility that includes one or more storage units that store the first item;
identifying, by the server, based on the first request, the first storage unit of the one or more storage units for picking the first item, wherein the first item is to be picked from a first slot of the first storage unit;
determining, by the server, whether picking the first item from the first slot shifts the COG of the first storage unit out of a COG tolerance region of the first storage unit;
in response to determining that picking the first item from the first slot shifts the COG out of the COG tolerance region of the first storage unit,
(i) identifying, by the server, a first set of slots for rearranging a first set of items remaining in the first storage unit after the first item is picked, such that rearranging the first set of items in the first set of slots maintains the COG within the COG tolerance region; and
(ii) communicating, by the server to an instruction device associated with an operator, a pick instruction to pick the first item from the first slot and a rearrangement instruction to rearrange the first set of items in the first set of slots.

16. The method of claim 15, further comprising:
determining, by the server, the COG tolerance region of the first storage unit based on at least one of a size of the first storage unit, a first set of dimensions of the first storage unit, a weight of the first storage unit, a shape of the first storage unit, or a configuration of the first storage unit.

17. The method of claim 15, further comprising:
determining, by the server, a risk score for each of a plurality of slots in the first storage unit before picking the first item, wherein the first set of slots is identified by the server based on the risk score determined for each slot of the plurality of slots.

18. The method of claim 17, wherein the risk score for each slot of the plurality of slots is determined by the server based on at least one of a first set of dimensions of the first storage unit, a second set of dimensions of each slot of the plurality of slots and at least one of a weight of each item in the first set of items, a type of each item in the first set of items, a shape of each item in the first set of items, or a third set of dimensions of each item in the first set of items.

19. The method of claim 15, further comprising:
receiving, by the server from the instruction device, a notification indicating that the first item is picked from the first storage unit based on the pick instruction and the first set of items is rearranged in the first set of slots based on the rearrangement instruction.

20. The method of claim 19, further comprising:
receiving, by the server from the instruction device, a notification indicating that the first item is picked from the first storage unit based on the pick instruction and the first set of items is rearranged in a second set of slots of the first storage unit, wherein the second set of slots is different from the first set of slots; and
generating, by the server, a response to the notification when the rearrangement of the first set of items in the second set of slots shifts the COG of the first storage unit out of the COG tolerance region.
